(19) United States
(12) Patent Application Publication
(10) Pub. No.: US 2010/0190077 A1
(43) Pub. Date: Jul. 29, 2010

(54) FUEL CELL SYSTEM AND ELECTRONIC APPARATUS

(75) Inventor: Jusuke SHIMURA, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/687,422

(22) Filed: Jan. 14, 2010

(30) Foreign Application Priority Data
Jan. 23, 2009 (JP) 2009-013102

(51) Int. Cl. H01M 8/04

(52) U.S. Cl. 429/443; 429/444

(57) ABSTRACT

A fuel cell system includes a power generator configured to generate electricity through supply of an oxidant gas and a fuel composed of a compound containing a carbon atom; a concentration detector configured to detect a concentration of carbon dioxide (CO₂); and a controller configured to operate so as to allow the power generator to generate electricity when the concentration of carbon dioxide detected by the concentration detector is lower than a predetermined threshold concentration and so as to stop a generating operation of the power generator when the concentration of carbon dioxide detected is higher than or equal to the threshold concentration.

### BACKGROUND OF THE INVENTION

1. Field of the Invention

The present invention relates to a fuel cell system including a power generator that uses a compound containing a carbon atom as a fuel and to an electronic apparatus including the fuel cell system.

2. Description of the Related Art

A cell is a device that extracts, as electricity, energy generated through a chemical reaction between a material to be oxidized and a material to be reduced. A primary cell such as a dry cell is a cell in which these two types of materials are packed in a single can. When both of the materials are completely consumed, the chemical reaction is stopped and thus the power supply is stopped. In contrast, a secondary cell uses, as a material to be oxidized, a material that can be electrically reduced repeatedly and also uses, as a material to be reduced, a material that can be electrically oxidized repeatedly. Thus, the state of a secondary cell can be repeatedly returned to its initial state by charging.

A fuel cell is a device that extracts electricity through a chemical reaction between a material to be oxidized and a material to be reduced as in the cell described above, but a fuel cell has a mechanism in which both of the material to be oxidized and the material to be reduced are supplied from the outside. Thus, a fuel cell can generate electric power semipermanently in principle. Since such a fuel cell often uses oxygen in the air as a material to be reduced, the material that is actually supplied is usually only a material to be oxidized. A fuel cell can drive devices semipermanently without changing a cell or performing charging unlike a primary cell or a secondary cell. Therefore, fuel cells are being widely researched and developed in the industrial and academic communities at present as a technology that can impart an unprecedented new value to products (e.g., refer to Japanese Unexamined Patent Application Publication No. 2006-253046).

For example, hydrogen gas, a precursor that generates hydrogen gas, methanol, and ethanol have been investigated as fuel (materials to be oxidized) used for a fuel cell. Since hydrogen gas (H₂) is changed to water (H₂O) by oxidation, a fuel cell using hydrogen as fuel produces only water vapor as an exhaust gas, which means such a fuel cell is extremely clean. However, it is quite difficult to safely handle hydrogen gas because of its explosiveness. Therefore, a hydrogen fuel cell is not so suitable as a fuel cell to be used in a portable electronic apparatus. It is believed that a fuel cell using a liquid fuel such as methanol or ethanol has potential for a portable electronic apparatus.

### SUMMARY OF THE INVENTION

However, the above-described fuel cell using, as a fuel, a compound including a carbon atom such as methanol, ethanol, dimethyl ether, formic acid, methyl formate, ethylene glycol, or glucose has a disadvantage in that carbon dioxide is produced as an exhaust gas (e.g., refer to Japanese Unexamined Patent Application Publication No. 2006-253046). In addition, since the chemical reaction of the fuel cell continues as long as oxygen is present, there is a problem in that an oxygen deficiency is caused by ambient oxygen being completely consumed.

In particular, a portable device is possibly used in a hermetic environment such as the inside of a pocket or a bag that has high hermeticity and is not sufficiently ventilated. Thus, if a small animal such as a pet is put in the bag together with such a portable device, the small animal may be suffocated (e.g., refer to Japanese Unexamined Patent Application Publication No. 11-235395).

For example, in a methanol fuel cell, the oxidation reaction of fuel incompletely proceeds just before the power generation stops due to an oxygen deficiency, which may produce by-products having high toxicity such as carbon monoxide, formaldehyde, and formic acid (e.g., refer to Japanese Unexamined Patent Application Publication No. 2006-253046). These by-products may impair user's health through exposure. Furthermore, these by-products may simply cause a nasty smell and the alteration of the things inside a bag.

In view of the foregoing problems, it is desirable to provide a fuel cell system whose safety is higher than before and an electronic apparatus including such a fuel cell system.

A fuel cell system according to an embodiment of the present invention includes a power generator configured to generate electricity through the supply of an oxidant gas and a fuel composed of a compound containing a carbon atom; a concentration detector configured to detect the concentration of carbon dioxide (CO₂); and a controller configured to operate so as to allow the power generator to generate electricity when the concentration of carbon dioxide detected by the concentration detector is lower than a predetermined threshold concentration and so as to stop a generating operation of the power generator when the concentration of carbon dioxide detected is higher than or equal to the threshold concentration.

An electronic apparatus according to an embodiment of the present invention includes the fuel cell system described above.

In the fuel cell system and electronic apparatus according to an embodiment of the present invention, electricity is generated in the power generator through the supply of an oxidant gas and a fuel composed of a compound containing a carbon atom. Herein, carbon dioxide (CO₂) is produced in the power generator through a chemical reaction and then discharged to the outside of the power generator. The concentration of carbon dioxide is detected by the concentration detector. When the concentration of carbon dioxide detected is lower than a predetermined threshold concentration, the controller operates so as to allow the power generator to generate electricity. When the concentration of carbon dioxide detected is higher than or equal to the threshold concentration, the controller operates so as to stop a generating operation of the power generator. This avoids a risk that the user of the fuel cell system and people or living things around the fuel cell system are poisoned due to carbon dioxide and the by-products thereof.

In the fuel cell system and electronic apparatus according to an embodiment of the present invention, a concentration detector detects the concentration of carbon dioxide and a controller operates so as to allow the power generator to generate electricity when the concentration of carbon dioxide detected is lower than a predetermined threshold concentration and so as to stop a generating operation of the power generator when the concentration of carbon dioxide detected is higher than or equal to the threshold concentration. Therefore, a risk that the user or the like of the fuel cell system is poisoned due to carbon dioxide and the by-products thereof can be avoided and the safety can be further improved.

### BRIEF DESCRIPTION OF THE DRAWINGS

FIG. 1 is a block diagram showing the entire configuration of a fuel cell system according to an embodiment of the present invention;

FIG. 2 is a perspective view showing an example of a schematic structure of the power generator and the partition wall shown in FIG. 1;

FIG. 3 is a sectional view showing an example of a schematic structure of the partition wall or the like of the power generator shown in FIG. 2;

FIG. 4 is a sectional view showing an example of the detailed structure of the power generator or the like shown in FIG. 3;

FIG. 5 is a characteristic diagram for describing the overview of a fuel supply system that uses vaporization;

FIG. 6 is a schematic view for describing an example of an operation controlled in accordance with the concentration of carbon dioxide detected in a surrounding environment;

FIGS. 7A to 7D are characteristic diagrams showing examples of relationships between the elapsed time of power generation and the concentrations of carbon dioxide and the by-products thereof; and

FIG. 8 is a block diagram showing the entire configuration of a fuel cell system according to a modification of the present invention.

### DESCRIPTION OF THE PREFERRED EMBODIMENTS

An embodiment of the present invention will be described in detail with reference to the attached drawings. The embodiment is described in the following order.

### 1. Embodiment (Configuration Example in Fuel Cell System)

### 2. Modification and Application.

### 1. Embodiment

### Entire Configuration Example of Fuel Cell System

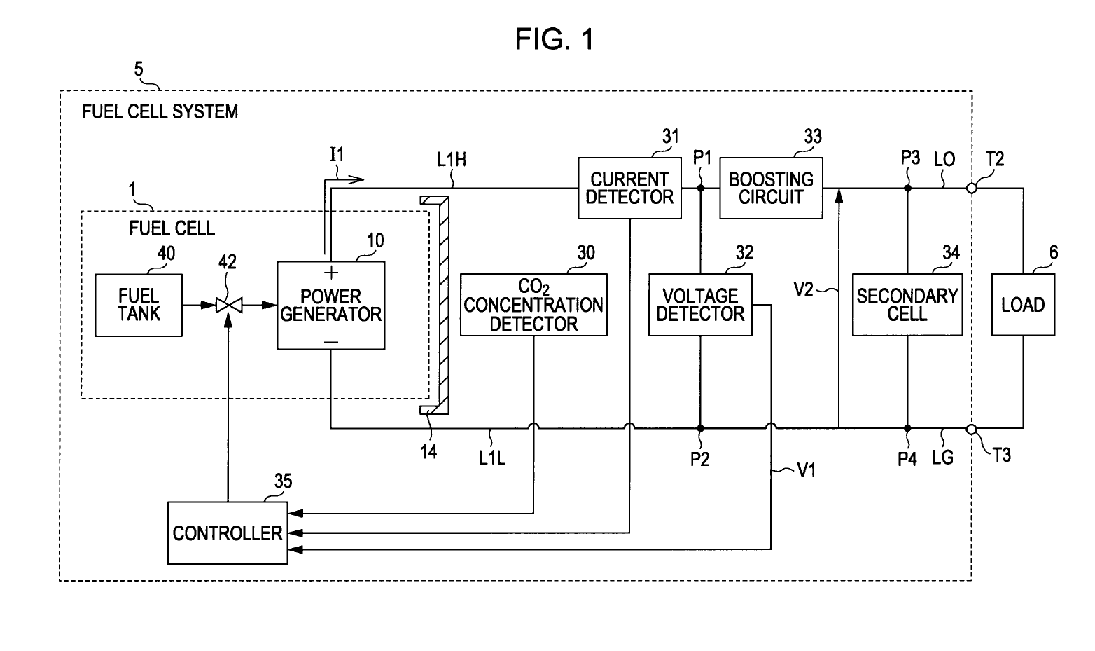

FIG. 1 shows the entire configuration of a fuel cell system (fuel cell system 5) according to an embodiment of the present invention. The fuel cell system 5 supplies electric power for driving a load 6 through output terminals T2 and T3. The fuel cell system 5 includes a fuel cell 1, a CO₂ concentration detector 30, a partition wall 14, a current detector 31, a voltage detector 32, a boosting circuit 33, a secondary cell 34, and a controller 35.

The fuel cell 1 includes a power generator 10, a fuel tank 40, and a fuel pump 42. The detailed structure of the fuel cell 1 will be described later.

The power generator 10 is a direct methanol power generator that generates electricity using a reaction between an oxidant gas (e.g., oxygen) and methanol, which is a fuel composed of a compound containing a carbon atom. The power generator 10 includes a plurality of unit cells each having a cathode (oxygen electrode) and an anode (fuel electrode). Ethanol, glucose, or the like may be used as such a fuel composed of a compound containing a carbon atom in addition to methanol. The detailed structure of the power generator 10 will be described later.

The fuel tank 40 contains a liquid fuel (liquid fuel 41 described below, for example, a methanol or ethanol solution) that is necessary for power generation.

The fuel pump 42 is a pump configured to pump up the liquid fuel contained in the fuel tank 40 and to supply (convey) the liquid fuel to the anode (fuel electrode) side of the power generator 10. The fuel pump 42 can adjust the supply amount of fuel. For example, the fuel pump 42 has a piezoelectric pump including a piezoelectric element (not shown) and pumping is performed using the vibration of the piezoelectric element. The operation of the fuel pump 42 (supply of liquid fuel) is controlled by the controller 35 described below. The detailed structure of the fuel pump 42 will be described later.

The CO₂ concentration detector 30 detects the concentration of carbon dioxide in the surrounding environment of the power generator 10 (concentration of carbon dioxide in an external environment). Although the detail is described later, the CO₂ concentration detector 30 is disposed in a position apart from the power generator 10. The concentration information of carbon dioxide detected by the CO₂ concentration detector 30 is outputted to the controller 35. The CO₂ concentration detector 30 corresponds to one example of “a concentration detector” according to an embodiment of the present invention.

The partition wall 14 prevents carbon dioxide generated in the power generator 10 from directly reaching the CO₂ concentration detector 30. Specifically, the partition wall 14 is disposed between the power generator 10 and the CO₂ concentration detector 30, whereby the CO₂ concentration detector 30 is not affected by carbon dioxide produced in the power generator 10 and carbon dioxide is released to the outside air. For example, such a partition wall 14 has a structure in which the power generator 10 is disposed outside the tube-shaped structural body that is the partition wall 14 and the CO₂ concentration detector 30 is disposed inside the tube-shaped structural body while both ends of the structural body directly communicate with the outside of the fuel cell system.

The current detector 31 is disposed on an interconnection line L1H between the cathode of the power generator 10 and a node P1 and detects a generated current I1 from the power generator 10. The current detector 31 includes, for example, a resistor. The current detector 31 may be disposed on an interconnection line L1L (between the anode of the power generator 10 and a node P2).

The voltage detector 32 is disposed between the node P1 on the interconnection line L1H and the node P2 on the interconnection line L1L and detects a generated voltage V1 (input voltage Vin of the boosting circuit 33) from the power generator 10. The voltage detector 32 includes, for example, a resistor.

The boosting circuit 33 is disposed between the node P1 on the interconnection line L1H and a node P3 on an output line LO. The boosting circuit 33 is a voltage transducer that generates a direct-current voltage V2 by boosting the generated voltage V1 (direct-current voltage) from the power generator 10. The boosting circuit 33 includes, for example, a DC-DC converter.

The secondary cell 34 is disposed between the node P3 on the output line LO and a node P4 on a grounding line LG (interconnection line L1L). The secondary cell 34 stores electricity in accordance with the direct-current voltage V2 generated by the boosting circuit 33. The secondary cell 34 is constituted by, for example, a lithium-ion secondary cell.

The controller 35 adjusts the amount of liquid fuel supplied using the fuel pump 42 in accordance with the generated current I1 detected by the current detector 31, the generated voltage V1 detected by the voltage detector 32, and the CO₂ concentration detected by the CO₂ concentration detector 30. Specifically, the amount of liquid fuel supplied using the fuel pump 42 is adjusted by controlling the oscillation frequency of the piezoelectric element (not shown) in the fuel pump 42. The controller 35 includes, for example, a microcomputer.

In this embodiment, when the concentration of carbon dioxide detected by the CO₂ concentration detector 30 is lower than a predetermined threshold concentration described below, the controller 35 operates so as to allow the power generator 10 to generate electricity. When the concentration of carbon dioxide detected is higher than or equal to the threshold concentration, the controller 35 operates so as to stop the generating operation of the power generator 10. Specifically, the controller 35 controls the generating operation of the power generator 10 by adjusting the amount of liquid fuel supplied using the fuel pump 42 in accordance with the concentration of carbon dioxide detected. The detailed operation of the controller 35 will be described later.

### Detailed Configuration Example of Fuel Cell

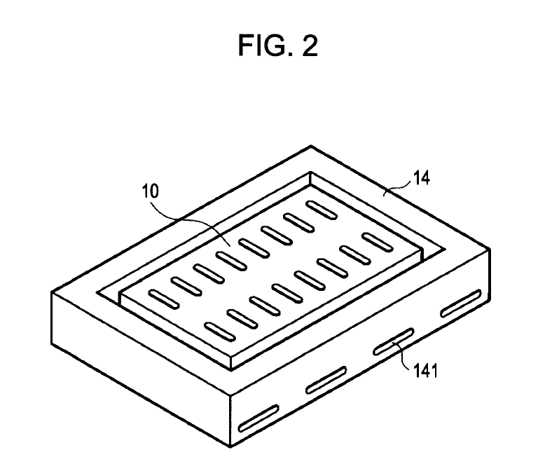

The detailed configuration of the fuel cell 1 will be described with reference to FIGS. 2 to 5. FIGS. 2 to 4 show examples of the detailed structures of the power generator 10 or the like in the fuel cell 1.

As shown in a perspective view of FIG. 2, the partition wall 14 is disposed so as to surround the side faces of the power generator 10 or the like. A natural air intake and outlet 141 for the outside air is disposed in the partition wall 14.

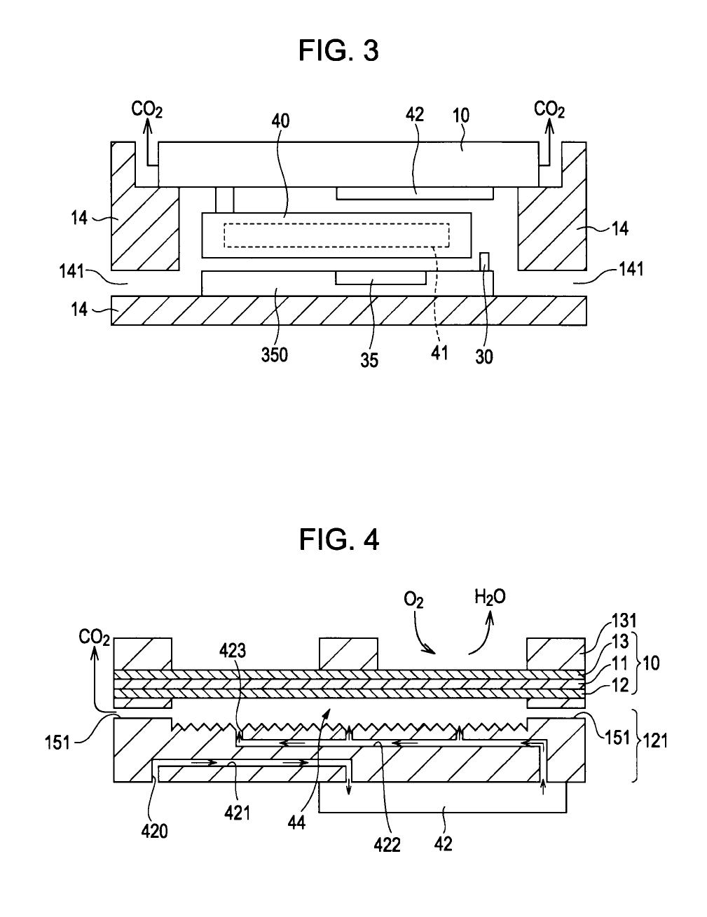

As shown in a sectional view of FIG. 3, the fuel tank 40 that contains the liquid fuel 41, the fuel pump 42, and a control board 350 including the controller 35 and the CO₂ concentration detector 30 are disposed under the power generator 10.

As described above, the CO₂ concentration detector 30 is disposed in a position apart from the power generator 10 so as to be exposed to the outside air. Furthermore, the partition wall 14 for preventing carbon dioxide from flowing into the CO₂ concentration detector 30 from the power generator 10 is disposed between the power generator 10 and the CO₂ concentration detector 30. The CO₂ concentration detector 30 is disposed in a region other than the site where carbon dioxide is produced in the power generator 10 and the route through which carbon dioxide is discharged from the site. Thus, the CO₂ concentration detector 30 is not affected by carbon dioxide produced in the power generator 10 and can detect the concentration of carbon dioxide in the surrounding environment of the power generator 10 (concentration of carbon dioxide in an external environment).

The fuel tank 40 includes, for example, a container (e.g., plastic bag) whose volume varies without mixing air bubbles therein even if the amount of the liquid fuel 41 is increased or decreased and a rectangular parallelepiped casing (structural body) that covers the container.

As shown in the detailed sectional view of FIG. 4, the power generator 10 includes a fuel electrode (anode electrode) 12 and an oxygen electrode (cathode electrode) 13 disposed on opposite sides of an electrolyte film 11. An anode-side retaining plate 121 is disposed under the fuel electrode 12 (opposite the oxygen electrode 13) and a cathode-side retaining plate 131 is disposed above the oxygen electrode 13 (opposite the fuel electrode 12).

The electrolyte film 11 is composed of, for example, a proton conductive material having a sulfonic acid group (—SO₃H). Examples of the proton conductive material include polyperfluoroalkyl sulfonic acid proton conductive materials (e.g., “Nafion” (registered trademark) available from DuPont), hydrocarbon proton conductive materials such as polyimide sulfonic acid, and fullerene proton conductive materials.

The fuel electrode 12 and the oxygen electrode 13 have a structure in which a catalyst layer containing a catalyst such as platinum (Pt) or ruthenium (Ru) is formed on a current collector made of carbon paper or the like. The catalyst layer is composed of a material obtained by dispersing a support body such as carbon black that supports a catalyst in a polyperfluoroalkyl sulfonic acid proton conductive material or the like. An air supply pump (not shown) may be connected to the oxygen electrode 13. Alternatively, the oxygen electrode 13 may communicate with the outside through an opening formed in the cathode-side retaining plate 131 such that air, that is, oxygen is supplied through natural ventilation.

For example, the anode-side retaining plate 121 and the cathode-side retaining plate 131 are each composed of a stainless laminated body made by diffusion bonding or an aluminum steel sheet subjected to stamping processing. The anode-side retaining plate 121 and the cathode-side retaining plate 131 are each connected to the power generator 10 through thread fastening, rivet connection, or resin connection. A fuel intake 420 and a flow passage 421 configured to take the liquid fuel 41 in from the fuel tank 40 and transfer the liquid fuel 41 to the fuel pump 42 are formed in the anode-side retaining plate 121. In addition, a flow passage 422 and fuel ejection ports 423 configured to transfer, to a fuel vaporizing chamber 44, the liquid fuel 41 supplied from the fuel pump 42 are formed in the anode-side retaining plate 121. A CO₂ gas outlet 151 configured to discharge carbon dioxide from the fuel vaporizing chamber 44 is also disposed in the anode-side retaining plate 121.

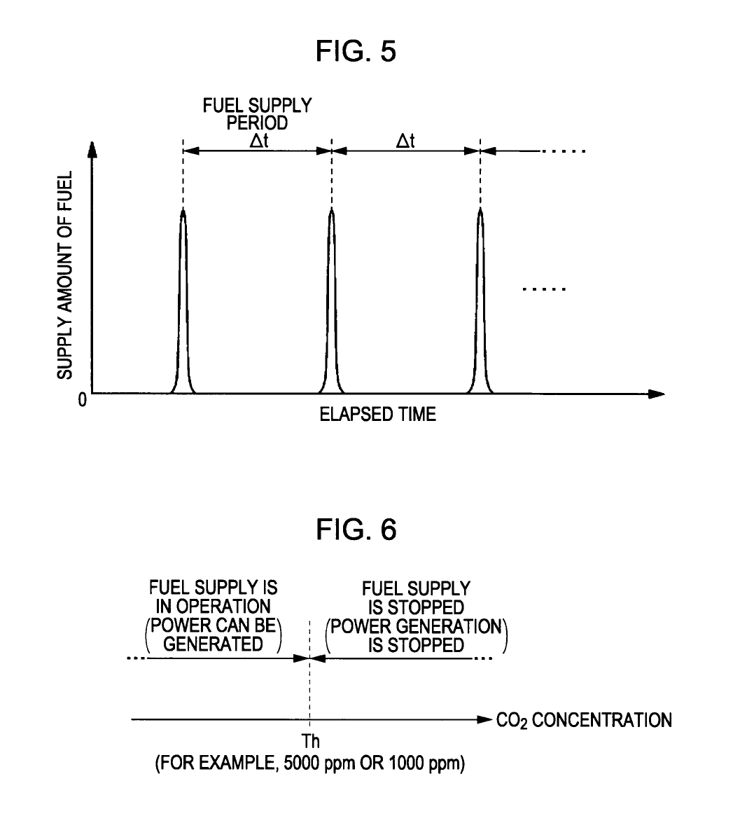

The fuel pump 42 includes, for example, a piezoelectric element (not shown) and a piezoelectric element-supporting resin member (not shown) configured to support the piezoelectric element. As shown in FIG. 5, for example, the fuel pump 42 can adjust the supply amount of fuel in accordance with the supply amount of fuel per single operation or the variation in a fuel supply period Δt. The fuel pump 42 corresponds to one example of “a fuel supply member” according to an embodiment of the present invention.

The fuel vaporizing chamber 44 is a space used for supplying gaseous fuel to the power generator 10 by vaporizing liquid fuel supplied using the fuel pump 42. In other words, the fuel vaporizing chamber 44 is disposed between the fuel pump 42 and the power generator 10. The fuel vaporizing chamber 44 corresponds to one example of “a fuel vaporizing member” according to an embodiment of the present invention.

### Operation and Advantage of Fuel Cell System

The operation and advantage of the fuel cell system 5 of this embodiment will be described in detail.

In this fuel cell system 5, the liquid fuel 41 contained in the fuel tank 40 is pumped up by the fuel pump 42 and reaches the fuel vaporizing chamber 44 flowing through the fuel intake 420, the flow passage 421, the flow passage 422, and the fuel ejection ports 423 in that order. In the fuel vaporizing chamber 44, when the liquid fuel 41 is ejected from the fuel ejection ports 423, the liquid fuel 41 is widely spread through a spreading portion (not shown) formed on the surface of the fuel vaporizing chamber 44. Thus, the liquid fuel 41 is naturally vaporized and the gaseous fuel is supplied to the power generator 10.

On the other hand, air (oxygen) is supplied to the oxygen electrode 13 of the power generator 10 using an air supply pump (not shown) or the like. In the fuel electrode 12, a reaction represented by the following formula (1) occurs and hydrogen ions, electrons, and carbon dioxide are produced. The hydrogen ions reach the oxygen electrode 13 through the electrolyte film 11. In the oxygen electrode 13, a reaction represented by the following formula (2) occurs and water is produced. Therefore, in the entire fuel cell 1, a reaction represented by the following formula (3) occurs and electricity is generated. The thus-produced carbon dioxide is discharged to the outside of the fuel cell 1 through the CO₂ gas outlet 151 as shown in FIGS. 3 and 4.

CH₃OH+H₂O→CO₂+6H⁺+6e⁻ (1)

6H⁺+(3/2)O₂+6e⁻→3H₂O (2)

CH₃OH+(3/2)O₂→CO₂+2H₂O (3)

This converts part of chemical energy of the liquid fuel 41, that is, methanol to electric energy. The electric energy is collected using a connection member 20 and extracted from the power generator 10 as an electric current (generated current I1). A generated voltage (direct-current voltage) V1 based on the generated current I1 is boosted into a direct-current voltage V2 using the boosting circuit 33 (voltage conversion). The direct-current voltage V2 is supplied to the secondary cell 34 or a load (e.g., electronic apparatus). When the direct-current voltage V2 is supplied to the secondary cell 34, electricity is stored in the secondary cell 34 in accordance with the voltage V2. When the direct-current voltage V2 is supplied to the load 6 through the output terminals T2 and T3, the load 6 is driven and a predetermined operation is performed.

In the fuel pump 42, the controller 35 controls the supply amount of fuel per single operation or the variation in a fuel supply period Δt and the oscillation frequency f of the piezoelectric element in the fuel pump 42. Thus, the supply amount of fuel is adjusted in accordance with the control of the controller 35.

In the fuel cell system 5 of this embodiment, the concentration of carbon dioxide in the surrounding environment of the power generator 10 (concentration of carbon dioxide in an external environment) is detected by the CO₂ concentration detector 30. As shown in FIG. 6, for example, when the concentration of carbon dioxide detected is lower than a predetermined threshold concentration Th, the controller 35 operates so as to allow the power generator 10 to generate electricity. When the concentration of carbon dioxide detected is higher than or equal to the threshold concentration Th, the controller 35 operates so as to stop the generating operation of the power generator 10.

Specifically, the controller 35 controls the generating operation of the power generator 10 by adjusting the supply amount of the liquid fuel 41 using the fuel pump 42 in accordance with the concentration of carbon dioxide detected. That is to say, as shown in FIG. 6, for example, when the concentration of carbon dioxide detected is lower than the threshold concentration Th, the controller 35 operates so as to allow the fuel pump 42 to supply the liquid fuel 41. When the concentration of carbon dioxide detected is higher than or equal to the threshold concentration Th, the controller 35 operates so as to stop the generating operation of the power generator 10 by stopping the fuel pump 42 from supplying the liquid fuel 41. This avoids a risk that the user of the fuel cell system 5 and people or living things around the fuel cell system 5 are poisoned due to carbon dioxide and the by-products thereof.

The threshold concentration Th shown in FIG. 6 can be, for example, 5000 ppm (0.5%) or 1000 ppm (0.1%) as shown in FIG. 6. A value of 5000 ppm comes from the environmental quality standard of labor health (refer to Ordinance on Health Standards in the Office, article 3-2). A value of 1000 ppm comes from the hygienic environmental quality standard in buildings (refer to Act on Maintenance of Sanitation in Buildings, article 2-A).

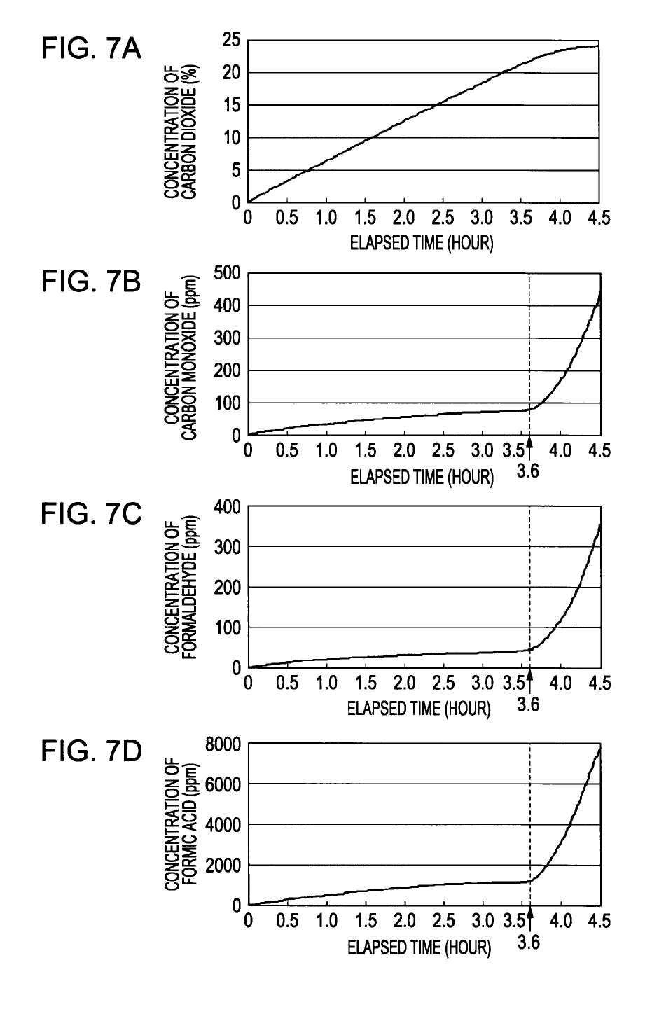

FIGS. 7A to 7D show examples of relationships between the elapsed time of power generation and the concentrations of carbon dioxide and the by-products thereof. FIG. 7A shows a relationship between elapsed time and concentration of carbon dioxide. FIG. 7B shows a relationship between elapsed time and concentration of carbon monoxide, which is a by-product. FIG. 7C shows a relationship between elapsed time and concentration of formaldehyde, which is a by-product. FIG. 7D shows a relationship between elapsed time and concentration of formic acid, which is a by-product.

Herein, to measure the process toward a direct methanol fuel cell ending up in an oxygen deficiency condition, a power generating experiment was performed while a power generating cell was contained in a hermetically sealed container having an internal volume of 6 L. The content of oxygen in this container was 0.5 mol. If 200 mA of power generation is continued at a usage rate of 80%, oxygen in the container will be completely consumed after 3.6 hours. The transition of gas concentrations in a hermetically sealed container was measured while electricity was generated under substantially the same conditions as those described above.

Referring to FIGS. 7A to 7D, the concentration of carbon dioxide was monotonically increased as electricity was generated and reached about 24% after 4.5 hours from the beginning of power generation. This concentration is substantially the same as the concentration of oxygen before the experiment. This means almost all oxygen in the air has been converted into carbon dioxide. The concentrations of carbon monoxide, formaldehyde, and formic acid were also monotonically increased as electricity was generated, and the concentrations thereof were suddenly increased after 3.6 hours from the beginning of power generation. Carbon monoxide, formaldehyde, and formic acid are all reaction intermediates produced by incomplete oxidation of methanol. Therefore, it is believed that the production rates were suddenly increased because the amount of ambient oxygen was decreased and thus methanol was not easily oxidized completely. Furthermore, it is understood that, if power generation is stopped when the concentration of carbon dioxide is 5000 ppm (0.5%), the generation of harmful materials in the oxygen deficiency conditions can be considerably suppressed, which significantly contributes to safety.

In this embodiment, the concentration of carbon dioxide in the surrounding environment of the power generator 10 (concentration of carbon dioxide in an external environment) is detected by the CO₂ concentration detector 30. When the concentration of carbon dioxide detected is lower than a predetermined threshold concentration Th, the controller 35 operates so as to allow the power generator 10 to generate electricity. When the concentration of carbon dioxide detected is higher than or equal to the threshold concentration Th, the controller 35 operates so as to stop the generating operation of the power generator 10. Therefore, a risk that the user or the like of the fuel cell system 5 is poisoned due to carbon dioxide and the by-products thereof can be avoided and the safety can be further improved.

Specifically, when the concentration of carbon dioxide detected is higher than or equal to the threshold concentration Th, the controller 35 operates so as to stop the generating operation of the power generator 10 by stopping the fuel pump 42 from supplying the liquid fuel 41. Therefore, the above-described advantages can be achieved.

### 2. Modification and Application

The present invention has been described using an embodiment. However, the present invention is not limited to the embodiment, and various modifications can be made.

For example, in the embodiment described above, the case where the threshold concentration Th of carbon dioxide is a fixed value has been described, but, for example, the threshold concentration Th may vary in accordance with the conditions or the like in a surrounding environment.

In the embodiment described above, the case where the partition wall 14 is disposed to prevent carbon dioxide generated in the power generator 10 from directly reaching the CO₂ concentration detector 30 has been described, but the arrangement of the CO₂ concentration detector 30 is not limited to the case. That is, by providing an outside air flow that flows in a certain direction using a heat source or a fan instead of providing such a partition wall, the concentration of carbon dioxide in the surrounding environment of the power generator 10 may be selectively detected. For example, in the case where an outside air flow that flows in a certain direction is present, the CO₂ concentration detector 30 is disposed on the upstream side (high pressure region) of the outside air flow while the power generator 10 is disposed on the downstream side (low pressure region) of the outside air flow, whereby the outside air is constantly taken in on the upstream side.

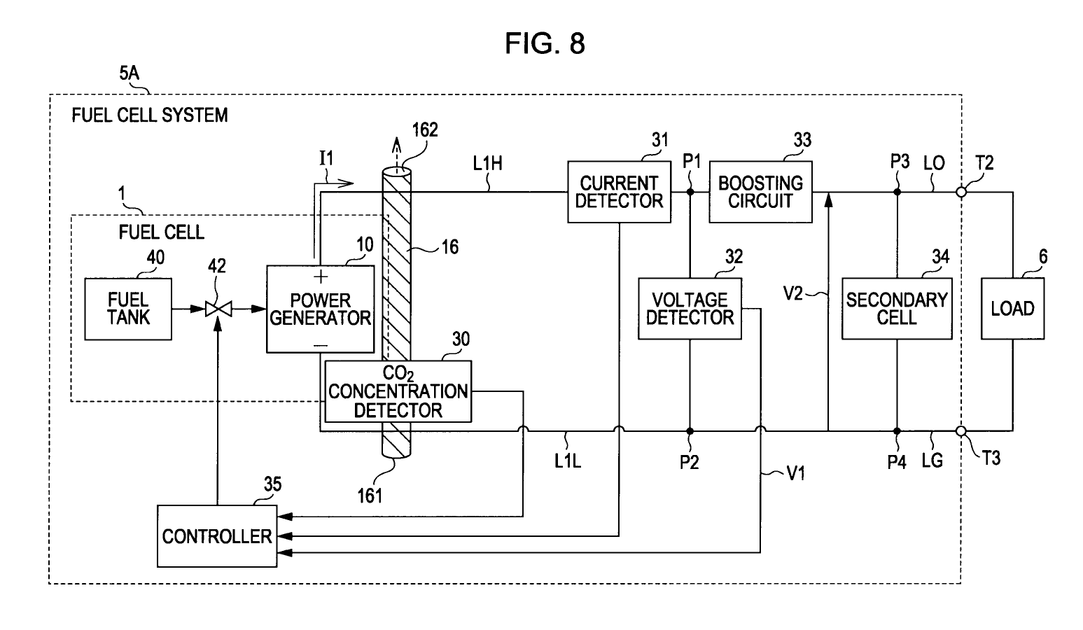

Alternatively, for example, the above-described outside air flow may be generated using the power generator 10 itself as a heat source as in a fuel cell system 5A shown in FIG. 8. Specifically, in the fuel cell system 5A, an exhaust duct 16 is disposed so as to be thermally in contact with the power generator 10. Furthermore, the CO₂ concentration detector 30 is disposed on the air intake 161 side (upstream side) of the exhaust duct 16 while the power generator 10 is disposed on the air outlet 162 side (downstream side). In such a structure, a portion of the exhaust duct 16 that is in contact with the power generator 10 is heated with heat produced in the power generator 10, whereby an outside air flow is generated in the exhaust duct 16. Thus, the concentration of carbon dioxide in the surrounding environment of the power generator 10 can be selectively detected by the CO₂ concentration detector 30 without separately providing another heat source or fan or without providing the partition wall 14 described in the embodiment. In this case, however, the air intake 161 of the exhaust duct 16 has to be disposed in the direction of gravitational force (that is, downward direction).

In the embodiment described above, the case where the fuel tank 40 containing the fuel liquid 41 is encased in the fuel cell system 5 has been described, but such a fuel tank may be detachable from the fuel cell system.

In the embodiment described above, a vaporization supply type fuel pump has been described as an example, but the configuration of a fuel pump is not limited to such a vaporization supply type. Specifically, the present invention can be applied in a method in which, for example, the flow rate of liquid fuel is adjusted using a fuel valve while a fuel tank is being pressured.

In the embodiment described above, a direct methanol fuel cell system has been described, but the present invention can be applied to other types of fuel cell systems. Specifically, the present invention can be applied to a fuel cell system that uses, for example, dimethyl ether, formic acid, methyl formate, ethanol, ethylene glycol, or glucose as a fuel.

A fuel cell system according to an embodiment of the present invention can be suitably used for portable electronic apparatuses such as a cellular phone, a digital camera, an electronic notepad, and a personal digital assistant (PDA).

The present application contains subject matter related to that disclosed in Japanese Priority Patent Application JP 2009-013102 filed in the Japan Patent Office on Jan. 23, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A fuel cell system comprising:
a power generator configured to generate electricity through supply of an oxidant gas and a fuel composed of a compound containing a carbon atom;
a concentration detector configured to detect a concentration of carbon dioxide (CO₂); and
a controller configured to operate so as to allow the power generator to generate electricity when the concentration of carbon dioxide detected by the concentration detector is lower than a predetermined threshold concentration and so as to stop a generating operation of the power generator when the concentration of carbon dioxide detected is higher than or equal to the threshold concentration.

2. The fuel cell system according to claim 1, further comprising:
a fuel supply member that supplies a liquid fuel composed of the compound to the power generator side and can adjust the supply amount of the liquid fuel; and
a fuel vaporizing member that supplies, to the power generator, a gas fuel obtained by vaporizing the liquid fuel supplied from the fuel supply member,
wherein the controller controls the generating operation of the power generator by adjusting the supply amount of the liquid fuel from the fuel supply member in accordance with the concentration of carbon dioxide detected.

3. The fuel cell system according to claim 2, wherein, when the concentration of carbon dioxide detected is higher than or equal to the threshold concentration, the controller operates so as to stop the generating operation of the power generator by stopping the fuel supply member from supplying the liquid fuel.

4. The fuel cell system according to claim 2, further comprising a fuel tank configured to contain the liquid fuel.

5. The fuel cell system according to any one of claims 1 to 4, wherein the concentration detector is configured to detect the concentration of carbon dioxide in a surrounding environment of the power generator.

6. The fuel cell system according to claim 5, wherein the concentration detector is disposed in a position apart from the power generator.

7. The fuel cell system according to claim 5, wherein the concentration detector is disposed in a region other than a site where carbon dioxide is produced in the power generator and a route through which carbon dioxide is discharged from the site.

8. The fuel cell system according to claim 5,
wherein a partition wall configured to prevent carbon dioxide generated in the power generator from directly reaching the concentration detector is disposed between the power generator and the concentration detector; and
the concentration detector is disposed so as to be exposed to outside air.

9. The fuel cell system according to claim 5,
wherein an outside air flow that flows in a certain direction is present; and
the concentration detector is disposed on the upstream side of the outside air flow while the power generator is disposed on the downstream side of the outside air flow.

10. The fuel cell system according to claim 9, further comprising:
a flow passage through which the outside air flow flows, the flow passage being disposed so as to be thermally in contact with the power generator,
wherein the outside air flow flows in a certain direction due to heat produced in the power generator.

11. The fuel cell system according to claim 1, wherein the threshold concentration is 5000 ppm.

12. The fuel cell system according to claim 1, wherein the threshold concentration is 1000 ppm.

13. The fuel cell system according to claim 1, wherein the fuel composed of the compound is methanol, dimethyl ether, formic acid, methyl formate, ethanol, ethylene glycol, or glucose.

14. An electronic apparatus comprising:
a fuel cell system,
wherein the fuel cell system includes a power generator configured to generate electricity through supply of an oxidant gas and a fuel composed of a compound containing a carbon atom; a concentration detector configured to detect a concentration of carbon dioxide (CO₂); and a controller configured to operate so as to allow the power generator to generate electricity when the concentration of carbon dioxide detected by the concentration detector is lower than a predetermined threshold concentration and so as to stop a generating operation of the power generator when the concentration of carbon dioxide detected is higher than or equal to the threshold concentration.
